(19) United States
(12) Patent Application Publication
(10) Pub. No.: US 2007/0048038 A1
(43) Pub. Date: Mar. 1, 2007

(54) Image forming apparatus

(75) Inventor: Kenji Koido, Tokyo (JP)

Correspondence Address: TAKEUCHI & KUBOTERA, LLP;SUITE 202, 200 DAINGERFIELD ROAD, ALEXANDRIA, VA, 22314, US

(73) Assignee: OKI DATA CORPORATION

(21) Appl. No.: 11/507,472

(22) Filed: Aug. 22, 2006

(30) Foreign Application Priority Data
Aug. 24, 2005 (JP) 2005-242168

(51) Int. Cl. G03G 15/20

(52) U.S. Cl. 399/324

(57) ABSTRACT

An image forming apparatus includes a developing device for forming a developer image containing at least a colorant, a releasing agent, and a binder resin; a transfer member for transferring the developer image to a recoding medium; and a oil-less fixing unit having a first rotational member for heating the developer image transferred to the recoding medium and a second rotational member for pressing the developer image against the recording medium. The first rotational member is coated with a release agent on a surface thereof.

### BACKGROUND OF THE INVENTION AND RELATED ART STATEMENT

The present invention relates to an image forming apparatus.

A conventional image forming apparatus such as a printer, a copier, and a facsimile is provided with a fixing unit. The fixing unit applies heat to a toner image on a medium for fixing the toner image to the medium. A certain type of fixing unit is adapted to perform a fixing operation called an oil fixing. In the oil fixing, when a fixing unit fixes a toner image to a sheet, a release agent such as silicone oil is continuously supplied to a surface of a fixing roller. Accordingly, it is possible to prevent the sheet from sticking to the fixing roller and from being wound with the fixing roller.

In the oil fixing, it is necessary to provide an oil supply mechanism for coating the release agent on the fixing roller, thereby increasing a size of the printer. To this end, there has been developed another type of fixing operation called oil-less fixing. In the oil-less fixing, toner contains a relatively large amount of release agent (refer to Patent Reference). Patent Reference: Japanese Patent Publication No. 11-327350

In the conventional oil-less fixing, once a printing operation starts, it is difficult to smoothly perform the fixing operation until a certain amount of release agent contained in toner sticks to a surface of a fixing roller, thereby deteriorating image quality at an initial stage of printing.

In view of the problems described above, an object of the present invention is to provide an image forming apparatus, in which it is possible to solve the problems in the conventional printer and improve image quality.

Further objects and advantages of the invention will be apparent from the following description of the invention.

### SUMMARY OF THE INVENTION

In order to attain the objects described above, according to the present invention, an image forming apparatus comprises: a developing device for forming a developer image containing at least a colorant, a releasing agent, and a binder resin; a transfer member for transferring the developer image to a recoding medium; and a oil-less fixing unit having a first rotational member for heating the developer image transferred to the recoding medium and a second rotational member for pressing the developer image against the recording medium. The first rotational member is coated with a release agent on a surface thereof.

With the configuration described above, the first rotational member is coated with the release agent in advance. Accordingly, it is possible to smoothly perform a fixing operation and improve image quality.

### BRIEF DESCRIPTION OF THE DRAWINGS

FIG. 1 is a schematic view showing a printer according to a first embodiment of the present invention;

FIG. 2 is a schematic view showing a developing device according to the first embodiment of the present invention;

FIG. 3 is a sectional view of a fixing unit according to the first embodiment of the present invention;

FIG. 4 is a schematic perspective view showing a method of coating oil according to the first embodiment of the present invention;

FIG. 5 is a schematic sectional view showing a release agent coating roller according to the first embodiment of the present invention;

FIG. 6 is a graph showing a relationship between the number of printed sheets and an amount of coated oil according to the first embodiment of the present invention;

FIG. 7 is a graph showing a relationship between an amount of coated oil and a fixing margin according to the first embodiment of the present invention; and

FIG. 8 is a graph showing a relationship between an amount of coated oil and brightness according to the first embodiment of the present invention.

### DETAILED DESCRIPTION OF PREFERRED EMBODIMENTS

Hereunder, embodiments of the present invention will be explained with reference to the accompanying drawings. In the embodiments, a color printer will be explained as an image forming apparatus.

First Embodiment

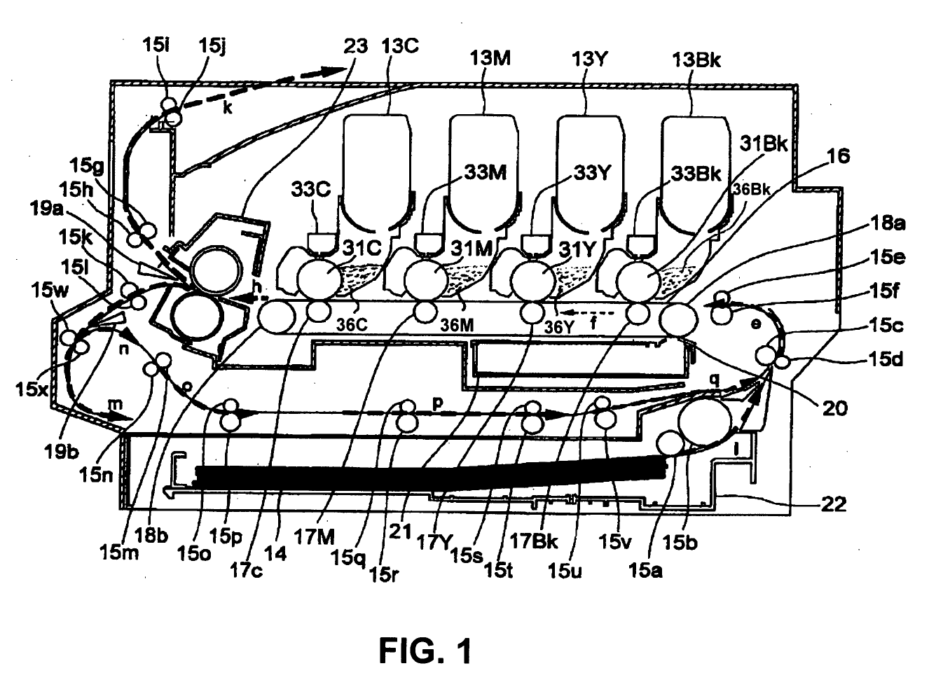

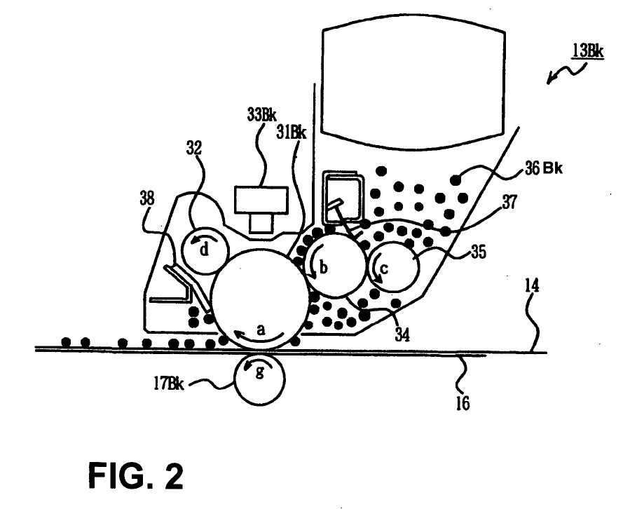

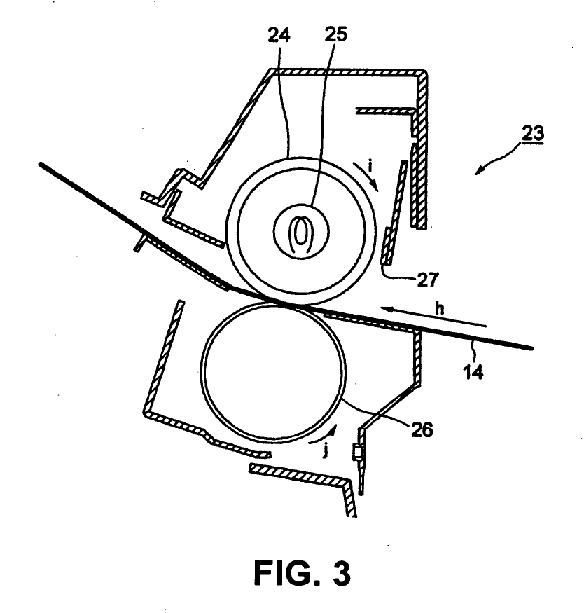

FIG. 1 is a schematic view showing a printer according to a first embodiment of the present invention. FIG. 2 is a schematic view showing a developing device according to the first embodiment of the present invention. FIG. 3 is a sectional view of a fixing unit according to the first embodiment of the present invention.

As shown in FIG. 1, the printer is provided with developing units or image forming units for black, yellow, magenta, and cyan 13Bk, 13Y, 13M, and 13C. The image forming units 13Bk, 13Y, 13M, and 13C are provided with image supporting members or photosensitive drums for black, yellow, magenta, and cyan 31Bk, 31Y, 31M, and 31C, respectively. The printer is also provided with a sheet cassette or medium storage member 22 for storing a sheet or recoding medium 14 and transport rollers 15a to 15x for transporting the sheet 14. The printer is further provided with a transfer belt, first transfer member, or transport member 16 for transferring an image from the image forming units; and transfer rollers or second transfer members for black, yellow, magenta, and cyan 17Bk, 17Y, 17M, and 17C disposed to face the photosensitive drums 31Bk, 31Y, 31M, and 31C through the transfer belt 16.

The printer is also provided with drive rollers 18a and 18b for driving the transfer belt 16; sheet transport guides or movable sheet guide members 19a and 19b for guiding the sheet 14; a transfer belt cleaning blade 20 for cleaning toner on the transfer belt 16; a waste developer tank 21 for collecting toner removed by the transfer belt cleaning blade 20; and a fixing unit or an oil-less fixing unit 23 for fixing a toner image formed on the sheet 14. The printer further includes LED heads or exposure units for black, yellow, magenta, and cyan 33Bk, 33Y, 33M, and 33C disposed to face the photosensitive drums for black, yellow, magenta, and cyan 31Bk, 31Y, 31M, and 31C. The drive rollers 18a and 18b rotate to move the transfer belt 16 in an arrow direction f.

The developing units for black, yellow, magenta, and cyan 13Bk, 13Y, 13M, and 13C will be explained in detail next. The developing units 13Bk, 13Y, 13M, and 13C have an identical structure, and only the developing unit for black 13Bk will be explained in the following description. As shown in FIG. 2, the developing unit 13Bk is provided with the image supporting member or photosensitive drum 31Bk formed of an organic photosensitive material. More specifically, the photosensitive drums 31Bk includes an aluminum pipe functioning as a conductive supporting member; a charge generating layer or photoconductive layer formed on the aluminum pipe; and a charge transporting layer formed on the charge generating layer.

The developing unit 13Bk is provided with a charge roller or charge unit 32 formed of a metal shaft and a semi-conductive epichlorohydrin rubber layer; the LED heat 33Bk disposed to face the photosensitive drum 31Bk; a developing roller or developer supporting member 34 formed of a metal shaft and a semi-conductive urethane rubber layer; a supply roller or developer supplying collecting member 35 formed of a metal shaft and a semi-conductive silicone foam layer for supplying toner or developer 36Bk formed of a polyester resin as a binder resin, an inner additive such as a charging control agent, a release agent, and a colorant, and an outer additive such as silica; a developing blade or developer control member 37 formed of stainless steel; and a cleaning member or cleaning blade 38 formed of a urethane rubber.

In the embodiment, in addition to a polyester resin, the binder resin may include a styrene-acrylic resin, an epoxy resin, and a styrene-butadiene resin.

The fixing unit 23 will be explained in detail next. As shown in FIG. 3, the fixing unit 23 includes a heating roller or first rotational member 24 formed of an aluminum core metal with a hollow cylindrical shape, a silicone rubber heat resistant elastic layer formed on the core metal, and a PFA (tetrafluoroethylene-perfluoroalkylvinylether copolymer) tube formed on the elastic layer; and a heater or heating member 25 formed of a halogen lump and disposed in the core metal of the heating roller 24.

The fixing unit 23 is also provided with a pressing roller or second rotational member 26 formed of an aluminum core metal, a silicone rubber heat resistant elastic layer formed on the core metal, and a PFA tube formed on the elastic layer and disposed to form a pressing portion between with the heating roller 24; and a thermistor or temperature detection member 27 disposed adjacent to a surface of the heating roller 24 in a non-contact state relative to the heating roller 24 for detecting a temperature of the surface of the heating roller 24.

The printer is provided with a temperature control unit of a control unit (not shown) for controlling a temperature of the heating roller 24 detected by the thermistor 27. More specifically, the temperature control unit switches on and off the heater 25 according to a temperature of the heating roller 24 detected by the thermistor 27, thereby maintaining the temperature at a specific level.

In the embodiment, the heating member or heater 25 includes a halogen lump or a ceramic heater, and may include any type of heater for generating heat. Further, instead of the PFA tube, the heating roller 24 or the pressing roller 26 may be coated with a fluoro-rubber, Teflon (trade mark), or nylon.

An operation of the printer will be explained next. In an image forming process, a motor or driving unit (not shown) drives the photosensitive drum 31Bk to rotate at a specific circumferential speed in an arrow direction a. With the rotation, the charge roller 32 contacting with the photosensitive drum 31Bk rotates in an arrow direction d. A charge roller high voltage power source (not shown) applies a direct current voltage to the photosensitive drum 31Bk, thereby uniformly charging the surface of the photosensitive drum 31Bk.

In an exposure process, the LED head 33Bk irradiates light corresponding to an image signal to the photosensitive drum 31Bk, thereby forming a latent image on the photosensitive drum 31Bk.

In a developing process, the supply roller 35 rotates in an arrow direction c. A supply roller high voltage power source (not shown) applies a specific voltage to the supply roller 35, so that the toner 36Bk is supplied to the developing roller 34. The developing roller 34 contacting with the photosensitive drum 31Bk rotates in an arrow direction b. A developing roller high voltage power source (not shown) applies a specific voltage to the developing roller 34, so that the toner 36Bk supplied from the supply roller 35 sticks to the developing roller 34. The developing blade 37 is disposed at a downstream side of the supply roller 35 in a rotational direction thereof to abut against the developing roller 34, so that the developing blade 37 forms a toner layer with a uniform thickness on the developing roller 34. The developing roller 34 attaches the toner 36Bk to the latent image on the photosensitive drum 31Bk thereby forming the toner image through a reverse process.

More specifically, when a toner supporting member high voltage power source (not shown) applies a bias voltage between the metal pipe of the photosensitive drum 31Bk and the developing roller 34, an electrical force line associated with the latent image on the photosensitive drum 31Bk is generated between the photosensitive drum 31Bk and the developing roller 34. Accordingly, the toner 36Bk charged on the developing roller 34 sticks to the photosensitive drum 31Bk through a static force, thereby forming the toner image through the reverse process.

The sheet transport rollers 15a and 15b transport the sheet 14 stored in the sheet cassette 22, and the sheet transport rollers 15c to 15f transport the sheet 14 to the transfer belt 16 in an arrow direction e. Then, the transfer belt 16 transports the sheet 14 in an arrow direction f.

In a transfer process, the photosensitive drum 31Bk rotates in an arrow direction g. When a transfer roller high voltage power source (not shown) applies a specific voltage to the transfer roller 17Bk, the toner image in black on the photosensitive drum 31Bk is transferred to the sheet 14. Through a similar process, the transfer roller 17Y transfers the toner image in yellow to the sheet 14; the transfer roller 17M transfers the toner image in magenta to the sheet 14; and the transfer roller 17C transfers the toner image in cyan to the sheet 14, thereby forming an image in color. Afterward, the sheet 14 is transported to the fixing unit 23 in an arrow direction h.

In a fixing process, the sheet 14 with the toner image transferred thereon is transported between the heating roller 24 rotating in an arrow direction i and the pressing roller 26 rotating in an arrow direction j. At the location, the heating roller 24 melts the toner image on the sheet 14, and the heating roller 24 and the pressing roller 26 press the toner image at the pressing portion thereof, thereby fixing the toner image on the sheet 14 to form the color image. Afterward, the sheet transport rollers 15g to 15j transport the sheet 14 outside the printer in an arrow direction k.

A small amount of the toner 36Bk may remain on the photosensitive drum 31Bk after the transfer process. In such a case, the cleaning blade 38 abutting against the photosensitive drum 31Bk removes the toner 36Bk remaining on the photosensitive drum 31Bk, so that the photosensitive drum 31Bk can be used repeatedly.

When a plurality of sheets is printed continuously, the toner 36Bk, 36Y, 36M, and 36C may be charged insufficiently. As a result, the toner 36Bk, 36Y, 36M, and 36C may be transferred to the transfer belt 16 from the developing units 13Bk, 13Y, 13M, and 13C. In such a case, in the embodiment, the transfer belt 16 moves in the arrow direction f, so that the transfer belt cleaning blade 20 removes the toner 36Bk, 36Y, 36M, and 36C from the transfer belt 16. Then, the toner 36Bk, 36Y, 36M, and 36C is collected in the waste developer tank 21, so that the transfer belt 16 can be used repeatedly.

A duplex printing process of the printer will be explained next. In the duplex printing process, a process of forming a color image on one side of the sheet 14 is the same as the process described above.

After the color image is formed on one side of the sheet 14 through a reverse transport path formed of the sheet transport rollers 15m to 15x in the arrow directions m, n, p, and q, the sheet 14 is transported in an arrow direction m with the sheet transport guide 19a and the sheet transport rollers 15k, 15l, 15w, and 15x. After a trailing edge of the sheet 14 passes the sheet transport guide 19b, when the trailing edge reaches the sheet transport rollers 15w and 15x, the sheet transport rollers 15w and 15x rotate in opposite directions, so that the trailing edge becomes a leading edge of the sheet 14. At this time, the sheet transport guide 19b is switched, so that the sheet 14 is transported in an arrow direction n.

Afterward, the sheet 14 is transported in arrow directions o, p, and q with the sheet transport rollers 15n to 15v, and then the sheet 14 is transported in the arrow direction e with the sheet transport rollers 15c and 15d. The sheet 14 moves in the arrow directions f and h, so that an image is formed on a backside of the sheet 14. When the sheet transport guide 19a as a selection unit is switched for selecting a sheet transport direction, the sheet 14 is transported in the arrow direction k through a discharge path formed of the sheet transport rollers 15g to 15j, and then is discharged outside the printer.

The toner 36Bk, 36Y, 36M, and 36C will be explained next. In manufacturing the toner for black 36Bk, 100 weight parts of a binder resin (polyester resin with a number average molecular weight of 3700 and a glass transition temperature of 62° C.); 1.0 weight parts of a charge control agent formed of salicylic acid complex (Bontoron E-84, a product of Orient Chemical Industries Inc.); 4.0 weight parts of colorant formed of carbon black (Mogul-L, a product of Cabot Corporation); and 5.0 weight parts of release agent formed of carnauba wax (carnauba wax No. 1 powder, a product of S. Kato & Co.) are mixed in a Henschel mixer. The mixture is melted and kneaded with a twin-screw kneading machine, and is crashed and classified to obtain powder with a crashing pulverizer (Dispersion separator, a produce of Nippon Pneumatic Manufacturing Co., Ltd.).

The powder has a volume average particle diameter of 6.5 pm measured with a cell counting analyzer (Coulter Multisizer, a product of Beckman Coulter K. K.) under an aperture diameter of 100 μm at 30000 count. Then, 2.0 weight parts of hydrophobic silica with a first order average diameter of 16 nm (R972, a product of NIPPON AEROSIL Co., Ltd.) is mixed with 100 weight parts of the powder. The mixture is stirred in a Henschel mixer with 10-liter capacity for three minutes at 3200 rotations per minute to obtain the toner for black 36Bk.

In manufacturing the toner for yellow 36Y, instead of the colorant formed of carbon black in the toner for black 36Bk, 4.0 weight parts of a pigment yellow 17 (ECY-215, a product of Dainichiseika Color & Chemicals Mfg. Co., Ltd.) is used in a manufacturing process same as that of the toner for black 36Bk. After obtaining powder with a volume average particle diameter of 6.5 μm, 2.0 weight parts of hydrophobic silica with a first order average diameter of 16 nm (R972, a product of NIPPON AEROSIL Co., Ltd.) is mixed with 100 weight parts of the powder. The mixture is stirred in a Henschel mixer with 10-liter capacity for three minutes at 3200 rotations per minute to obtain the toner for yellow 36Y.

In manufacturing the toner for magenta 36M, instead of the colorant formed of carbon black in the toner for black 36Bk, 4.0 weight parts of a pigment red 57:1 (ECR-101, a product of Dainichiseika Color & Chemicals Mfg. Co., Ltd.) is used in a manufacturing process same as that of the toner for black 36Bk. After obtaining powder with a volume average particle diameter of 6.5 μm, 2.0 weight parts of hydrophobic silica with a first order average diameter of 16 nm (R972, a product of NIPPON AEROSIL Co., Ltd.) is mixed with 100 weight parts of the powder. The mixture is stirred in a Henschel mixer with 10-liter capacity for three minutes at 3200 rotations per minute to obtain the toner for magenta 36M.

In manufacturing the toner for cyan 36C, instead of the colorant formed of carbon black in the toner for black 36Bk, 4.0 weight parts of a pigment blue 15:3 (ECB-301, a product of Dainichiseika Color & Chemicals Mfg. Co., Ltd.) is used in a manufacturing process same as that of the toner for black 36Bk. After obtaining powder with a volume average particle diameter of 6.5 μm, 2.0 weight parts of hydrophobic silica with a first order average diameter of 16 nm (R972, a product of NIPPON AEROSIL Co., Ltd.) is mixed with 100 weight parts of the powder. The mixture is stirred in a Henschel mixer with 10-liter capacity for three minutes at 3200 rotations per minute to obtain the toner for cyan 36C.

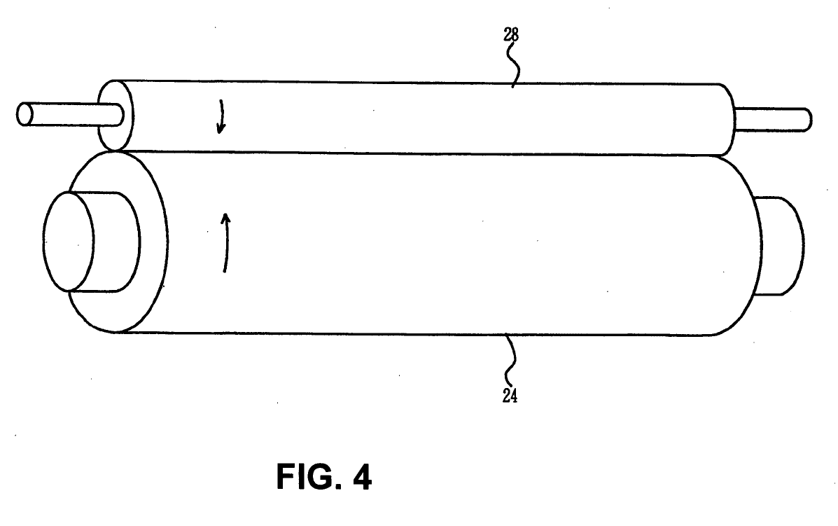

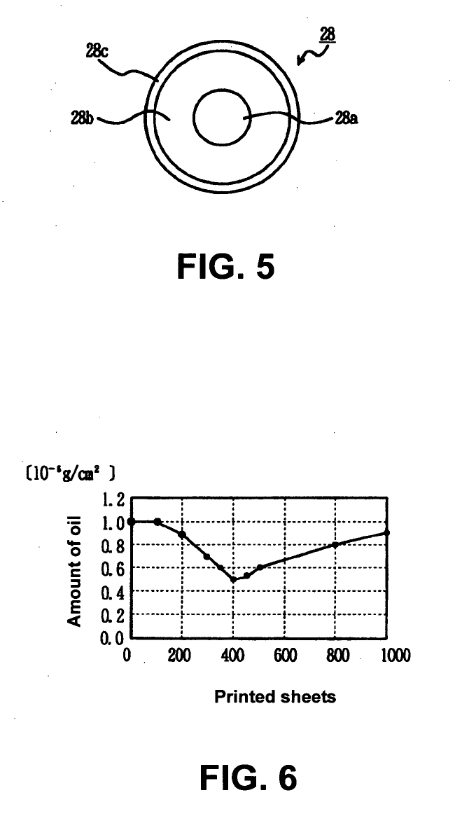

A method of coating oil or a release agent on the heating roller 24 will be explained next. FIG. 4 is a schematic perspective view showing the method of coating oil according to the first embodiment of the present invention. FIG. 5 is a schematic sectional view showing a release agent coating roller 28 according to the first embodiment of the present invention.

In the embodiment, the heating roller 24 is assembled in a state shown in FIG. 4 before installing in the fixing unit 23 (FIG. 3). Silicone oil is coated on the surface of the heating roller 24 with the release agent coating roller 28. In the embodiment, dimethyl-silicone oil with a dynamic viscosity of 100 cSt at 25° C. (KF96SS-100CS, a product of Shin-Etsu Chemical Co., Ltd.) is used as the release agent.

As shown in FIG. 5, the release agent coating roller 28 is formed of a metal core 28a with a diameter of 10 mm; a cylindrical portion or release agent holding member 28b with a diameter of 28 mm and having a heat resistant aluminosilicate for holding the release agent; and a release agent coating control layer 28c such as a multi-pored poly-tetrafluoroethylene (PTFE) layer formed in a tube shape on the cylindrical portion 28b.

The release agent coating roller 28 has a diameter of 30 mm and a length contacting with the heating roller 24 same as that of the heating roller 24 in a longitudinal direction. Before applying the oil on the release agent coating roller 28, a dry weight of the release agent coating roller 28 is measured. In coating the oil on the release agent coating roller 28 for a specific amount, the release agent coating roller 28 is immersed in a container filled with the oil, and a weight of the release agent coating roller 28 is measured after pulling out from the container filled with the oil. This process is repeated until the weight of the release agent coating roller 28 becomes a sum of the dry weight of the release agent coating roller 28 and the specific amount of the oil.

After the oil is absorbed in the release agent coating roller 28, the release agent coating roller 28 is disposed on the heating roller 24 as shown in FIG. 4, so that the release agent coating roller 28 contacts with the heating roller 24 with its own weight. A heater 25a is disposed at a center of the heating roller 24, and a drive source is connected to the heating roller 24 for driving the same. After the heater 25a heats the heating roller 24 until a portion of the release agent coating roller 28 contacting with the heating roller 24 becomes 100° C., the drive source connected to the heating roller 24 is driven to drive the heating roller 24 such that the portion of the release agent coating roller 28 contacting with the heating roller 24 rotates at a circumferential speed of 50 mm/sec, thereby coating the oil on the heating roller 24.

As described above, in the first embodiment, the release agent coating roller 28 with a diameter of 30 mm is immersed in dimethyl silicone oil as the oil. Then, the release agent coating roller 28 is heated to 100° C., and contacts with the heating roller 24 while rotating for a specific period of time, thereby coating dimethyl silicone oil on a whole outer circumferential surface of the heating roller 24 having a cylindrical shape.

A relationship between the number of printed sheets representing the number of image forming operations and an amount of dimethyl silicone or oil coated on the heating roller 24 will be explained next. In the following explanation, an amount of oil will be expressed in the following exponential form.

Example: 0.5E−6=5E−7=0.5×10⁻⁶=5×10⁻⁷

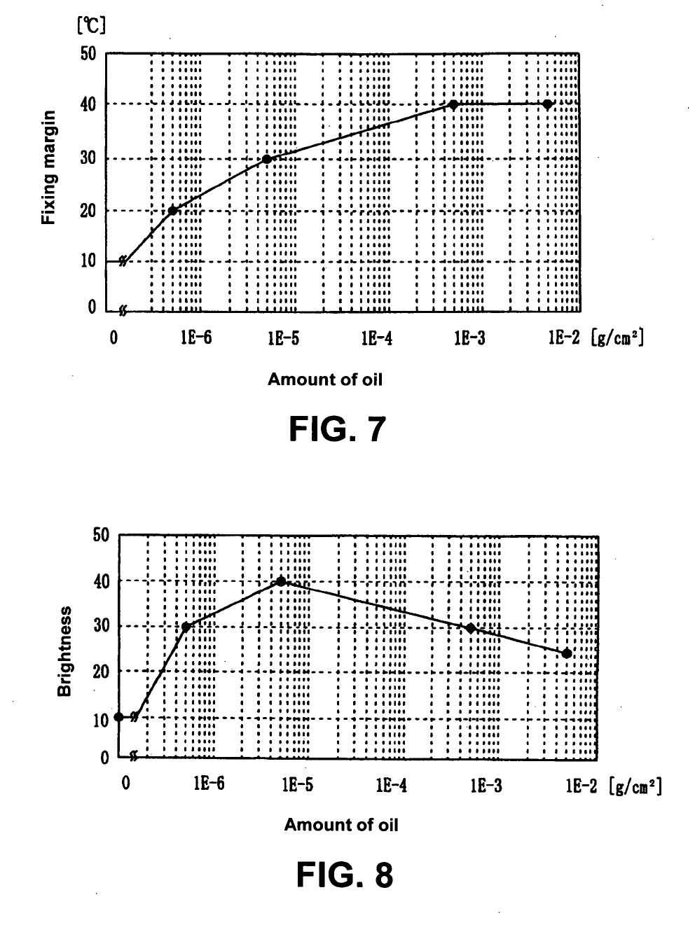

FIG. 6 is a graph showing the relationship between the number of printed sheets and an amount of oil coated on the heating roller 24 according to the first embodiment of the present invention. FIG. 7 is a graph showing a relationship between an amount of coated oil and a fixing margin according to the first embodiment of the present invention. FIG. 8 is a graph showing a relationship between an amount of coated oil and brightness according to the first embodiment of the present invention. In FIG. 6, the horizontal axis represents the number of printed sheets, and the vertical axis represents an amount of coated oil. In FIG. 7, the horizontal axis represents an amount of coated oil, and the vertical axis represents a fixing margin. In FIG. 8, the horizontal axis represents an amount of coated oil, and the vertical axis represents brightness.

### EXAMPLE 1-1

80 g of dimethyl silicone was coated on the release agent coating roller 28. Then, the release agent coating roller 28 contacted with the heating roller 24 while rotating for 300 seconds, thereby coating dimethyl silicone oil on the heating roller 24 at an amount of 1×10⁻⁶ g/cm². After the coating, the heating roller 24 was installed in the fixing unit 23 (FIG. 1), and the fixing unit 23 was installed in the printer shown in FIG. 1.

While the printer printed on a whole area of a sheet (100% duty) in black, voltages supplied to the developing roller 34 (FIG. 2) and the supply roller 35 were adjusted such that the toner 36Bk was attached to the sheet 14 at an amount of 0.50 mg/cm². Under this setting, the printer continuously printed patterns on sheets in 5% areas thereof in black (5% duty) relative to 100% duty for the whole area of the sheet. An A4 type standard sheet (for example, OKI Excellent White with a weight of 80 g/cm²) was used as the sheet 14. The printer printed on the sheets at a speed of 100 mm/second in the longitudinal direction. An amount of oil coated on the heating roller 24 was measured at various numbers of printed sheets.

In FIG. 6, an amount of coated oil represents a sum of oil initially coated on the heating roller 24 and oil oozing out from the toner 36Bk and stuck to the heating roller 24. As shown in FIG. 6, a minimum amount of oil on the heating roller 24 is 0.5×10⁻⁶ g/cm².

When a minimum amount of oil on the heating roller 24 was 0.5×10⁻⁶ g/cm², in the developing units for yellow, magenta, and cyan 13Y, 13M, and 13C, while toner images were transferred and overlapped at 100% duty to form a toner image at 300% duty in three colors, voltages supplied to the developing roller 34 (FIG. 2) and the supply roller 35 were adjusted such that the toner 36Y, 36M, and 36C was attached to the sheet 14 at an amount of 1.50 mg/cm². Under this setting, it was controlled such that the surface temperature of the heating roller 24 became 150° C., and the continuous printing, five sheets in the example, was conducted. As a result, it was possible to obtain high quality images without a fixing problem.

When it was controlled such that the surface temperature of the heating roller 24 became 160° C. and 170° C., it was possible to obtain high quality images without a fixing problem. When it was controlled such that the surface temperature of the heating roller 24 became 180° C., the sheet 14 was wound on the heating roller 24. As a result, a fixing problem occurred, and the sheet 14 was not properly discharged, thereby not obtaining an image. Further, when it was controlled such that the surface temperature of the heating roller 24 became 140° C., a toner image was partially scraped off the sheet 14, thereby not obtaining a high quality image.

Accordingly, a range of the surface temperature in which a high quality image was obtained without a fixing problem (a fixing margin) was found to be 20° C. (170° C. −150° C.=20° C.). In general, when a printer is used within a specific environmental range between high temperature and high humidity (28° C., 80%) and low temperature and low humidity (10° C., 20%), the fixing margin does not exceed 20° C. even though a temperature is varied due to heat loss of the sheet 14 during the fixing operation. Accordingly, when the fixing margin is 20° C., it is possible to obtain a high quality image and improve image quality.

### EXAMPLE 1-2

80 g of dimethyl silicone was coated on the release agent coating roller 28. Then, the release agent coating roller 28 contacted with the heating roller 24 while rotating for 400 seconds, thereby coating dimethyl silicone oil on the heating roller 24 at an amount of 1×10⁻⁵ g/cm².

Under a condition similar to that in Example 1-1, the continuous printing in single color was performed. It was found that a minimum amount of oil on the heating roller 24 was 0.5×10⁻⁵ g/cm². Under the condition in which a minimum amount of oil on the heating roller 24 was 0.5×10⁻⁵ g/cm², the printing in three colors was conducted without a fixing problem in a temperature range between 150° C. to 180° C. Accordingly, the fixing margin was found to be 30° C.

When it was controlled such that the surface temperature of the heating roller 24 became 190° C., the sheet 14 was wound on the heating roller 24. As a result, a fixing problem occurred, and the sheet 14 was not properly discharged, thereby not obtaining an image. Further, when it was controlled such that the surface temperature of the heating roller 24 became 140° C., a toner image was partially scraped off the sheet 14, thereby not obtaining a high quality image.

### EXAMPLE 1-3

80 g of dimethyl silicone was coated on the release agent coating roller 28. Then, the release agent coating roller 28 contacted with the heating roller 24 while rotating for 500 seconds, thereby coating dimethyl silicone oil on the heating roller 24 at an amount of 1×10⁻³ g/cm².

Under a condition similar to that in Example 1-1, the continuous printing in single color was performed. It was found that a minimum amount of oil on the heating roller 24 was 0.5×10⁻³ g/cm². Under the condition in which a minimum amount of oil on the heating roller 24 was 0.5×10⁻⁵ g/cm², the printing in three colors was conducted without a fixing problem in a temperature range between 150° C. to 190° C. Accordingly, the fixing margin was found to be 40° C.

When it was controlled such that the surface temperature of the heating roller 24 became 200° C., the sheet 14 was wound on the heating roller 24. As a result, a fixing problem occurred, and the sheet 14 was not properly discharged, thereby not obtaining an image. Further, when it was controlled such that the surface temperature of the heating roller 24 became 140° C., a toner image was partially scraped off the sheet 14, thereby not obtaining a high quality image.

### EXAMPLE 1-4

80 g of dimethyl silicone was coated on the release agent coating roller 28. Then, the release agent coating roller 28 contacted with the heating roller 24 while rotating for 600 seconds, thereby coating dimethyl silicone oil on the heating roller 24 at an amount of 1×10⁻² g/cm².

Under a condition similar to that in Example 1-1, the continuous printing in single color was performed. It was found that a minimum amount of oil on the heating roller 24 was 0.5×10⁻² g/cm². Under the condition in which a minimum amount of oil on the heating roller 24 was 0.5×10⁻² g/cm², the printing in three colors was conducted without a fixing problem in a temperature range between 150° C. to 190° C. Accordingly, the fixing margin was found to be 40° C.

When it was controlled such that the surface temperature of the heating roller 24 became 200° C., the sheet 14 was wound on the heating roller 24. As a result, a fixing problem occurred, and the sheet 14 was not properly discharged, thereby not obtaining an image. Further, when it was controlled such that the surface temperature of the heating roller 24 became 140° C., a toner image was partially scraped off the sheet 14, thereby not obtaining a high quality image.

### COMPARATIVE EXAMPLE 1-1

With the heating roller 24 with no dimethyl silicone oil coated thereon, the printing in three colors was conducted without a fixing problem in a temperature range between 150° C. to 160° C. Accordingly, the fixing.margin was found to be 10° C. When the fixing range is 10° C., it is possible to print a regular sheet at a room temperature. However, if a temperature of the heating roller 24 varies, or an environmental condition of the printer or a condition of the sheet 14 changes, it may be difficult to print without a fixing problem. Therefore, it is preferred to have a fixing margin larger than 10° C.

When it was controlled such that the surface temperature of the heating roller 24 became 170° C., the sheet 14 was wound on the heating roller 24. As a result, a fixing problem occurred, and the sheet 14 was not properly discharged, thereby not obtaining an image. Further, when it was controlled such that the surface temperature of the heating roller 24 became 140° C., a toner image was partially scraped off the sheet 14, thereby not obtaining a high quality image.

### COMPARATIVE EXAMPLE 1-2

50 g of dimethyl silicone was coated on the release agent coating roller 28. Then, the release agent coating roller 28 contacted with the heating roller 24 while rotating for 120 seconds, thereby coating dimethyl silicone oil on the heating roller 24 at an amount of 1×10⁻⁷ g/cm².

If the continuous printing in single color was performed under a condition similar to that in Example 1-1, it was presumed that no dimethyl silicone oil would remain on the heating roller 24. Therefore, in the state that a minimum amount of oil on the heating roller 24 was 0.5×10⁻⁷ g/Cm², the printing in three colors was conducted without a fixing problem in a temperature range between 150° C. to 160° C. Accordingly, the fixing margin was found to be 10° C. For the reason same as that in Comparative Example 1-1, with the fixing margin of 10° C., it is difficult to print without a fixing problem.

When it was controlled such that the surface temperature of the heating roller 24 became 170° C., the sheet 14 was wound on the heating roller 24. As a result, a fixing problem occurred, and the sheet 14 was not properly discharged, thereby not obtaining an image. Further, when it was controlled such that the surface temperature of the heating roller 24 became 140° C., a toner image was partially scraped off the sheet 14, thereby not obtaining a high quality image.

### COMPARATIVE EXAMPLE 1-3

80 g of dimethyl silicone was coated on the release agent coating roller 28. Then, the release agent coating roller 28 contacted with the heating roller 24 while rotating for 800 seconds, thereby coating dimethyl silicone oil on the heating roller 24 at an amount of 1×10⁻¹ g/cm².

Similar to Example 1-1, while the printer printed on a whole area of a sheet (100% duty) in black, voltages supplied to the developing roller 34 (FIG. 2) and the supply roller 35 were adjusted such that the toner 36Bk was attached to the sheet 14 at an amount of 0.50 mg/cm². Under this setting, the printer continuously printed patterns on sheets in 5% areas thereof in black (5% duty). An A4 type standard sheet was used as the sheet 14, and passed in a longitudinal direction. An amount of oil coated on the heating roller 24 was measured at various numbers of printed sheets, and it was found that a minimum amount of oil on the heating roller 24 was 0.5×10⁻² g/cm².

As compared with Example 1-4, even though an initial amount of oil coated on the heating roller 24 was increased, wax contained in toner was difficult to stick to the heating roller 24. In other words, it was difficult to increase a minimum amount of oil on the heating roller 24.

Under the condition that a minimum amount of oil on the heating roller 24 was 0.5×10⁻² g/cm², in the developing units for yellow, magenta, and cyan 13Y, 13M, and 13C, while toner images were transferred and overlapped at 100% duty to form a toner image at 300% duty in three colors, voltages supplied to the developing roller 34 (FIG. 2) and the supply roller 35 were adjusted such that the toner 36Y, 36M, and 36C was attached to the sheet 14 at an amount of 1.50 mg/cm². Under this setting, the printing in three colors was conducted without a fixing problem in a temperature range between 150° C. to 190° C. Accordingly, the fixing margin was found to be 40° C.

When it was controlled such that the surface temperature of the heating roller 24 became 200° C., the sheet 14 was wound on the heating roller 24. As a result, a fixing problem occurred, and the sheet 14 was not properly discharged, thereby not obtaining an image. Further, when it was controlled such that the surface temperature of the heating roller 24 became 140° C., a toner image was partially scraped off the sheet 14, thereby not obtaining a high quality image.

Table 1 shows results of Examples 1-1 to 1-4 and Comparative Examples 1—1 to 1-3.

TABLE 1

| | Amount | Minimum | Toner | | | | |
|---|---|---|---|---|---|---|---|
| | of | mount of | image | Normal | Sheet | | |
| | coated | coated | peeled off | printing | wound | Fixing | |
| | oil | oil | temperature | temperature | temperature | margin | |
| | (g/cm²) | (g/cm²) | (° C.) | (° C.) | (° C.) | (° C.) | Brightness |
| Example 1-1 | 1E−6 | 5E−7 | 140 | 150˜170 | 180 | 20 | 30 |
| Example 1-2 | 1E−5 | 5E−6 | 140 | 150˜180 | 190 | 30 | 40 |
| Example 1-3 | 1E−3 | 5E−4 | 140 | 150˜190 | 200 | 40 | 30 |
| Example 1-4 | 1E−2 | 5E−3 | 140 | 150˜190 | 200 | 40 | 25 |
| Comparative | 0 | 0 | 140 | 150˜160 | 170 | 10 | 10 |
| Example 1-1 | | | | | | | |
| Comparative | 1E−7 | N/A | 140 | 150˜160 | 170 | 10 | 10 |
| Example 1-2 | | | | | | | |
| Comparative | 1E−1 | 5E−3 | 140 | 150˜190 | 200 | 40 | 20 |
| Example 1-3 | | | | | | | |

As shown in Table 1, when an amount of oil coated on the heating roller 24 is greater than 1×10⁻⁶ g/cm² and a minimum amount of oil on the heating roller 24 is 0.5×10⁻⁶ g/cm², it is possible to obtain the fixing margin large enough for printing properly. In Table 1, brightness was measured for Examples 1-1 to 1-4 and Comparative Examples 1-1 to 1-3. FIG. 8 is a graph showing a relationship between an amount of coated oil and brightness according to the first embodiment of the present invention.

When brightness is greater than 25 upon printing an image in one color, it is said to be preferable for printing an image in full color. As shown in FIG. 8, in order to obtain brightness greater than 25, it is preferred to set a minimum amount of oil in a range of 0.5×10⁻⁶ g/cm² to 0.5×10⁻² g/cm², and set an initial amount of oil in a range of 1×10⁻⁶ g/cm² and 1×10⁻² g/cm². An experiment similar to that described above was conducted using toner manufactured through suspension polymerization or emulsion polymerization. It was found that a result similar to that described above was obtained.

As described above, in an initial state of the heating roller 24 of the fixing unit 23, when an amount of oil coated on the heating roller 24 is greater than 1×10⁻⁶ g/cm², preferably in a range of 1×10⁻⁶ g/cm² to 1×10⁻² g/cm², it is possible to print an image with good brightness. In the embodiment, among various types of silicone oil, dimethyl silicone oil is used as the release agent coated on the heating roller 24. Instead of dimethyl silicone oil, it is possible to use modified silicone oil or a mixture thereof such as fluoro silicone oil, phenyl silicone oil, amino-modified silicone oil, and mercapto silicone oil.

Second Embodiment

A second embodiment of the present invention will be explained next. Explanations of components in the second embodiment similar to those in the first embodiment are omitted. The components in the second embodiment similar to those in the first embodiment provide effects similar to those in the first embodiment.

In the second embodiment, similar to the first embodiment, before applying the release agent on the release agent coating roller 28, a dry weight of the release agent coating roller 28 is measured. In coating the release agent on the whole outer circumferential surface of the release agent coating roller 28 with a cylindrical shape for a specific amount, the release agent coating roller 28 is immersed in a container filled with at least one of release agents A to E, and a weight of the release agent coating roller 28 is measured after pulling out from the container. This process is repeated until the weight of the release agent coating roller 28 becomes a sum of the dry weight of the release agent coating roller 28 and the specific amount of the release agent.

After the release agent with the specific amount is absorbed in the release agent coating roller 28, the release agent coating roller 28 is disposed on the heating roller 24 with no release agent coated thereon as shown in FIG. 4, so that the release agent coating roller 28 contacts with the heating roller 24 with its own weight. The heater 25a is disposed at the center of the heating roller 24, and the drive source is connected to the heating roller 24 for driving the same. After the heater 25a heats the heating roller 24 until a portion of the release agent coating roller 28 contacting with the heating roller 24 becomes 100° C., the drive source connected to the heating roller 24 is driven to drive the heating roller 24 such that the portion of the release agent coating roller 28 contacting with the heating roller 24 rotates at a circumferential speed of 50 mm/sec, thereby coating the release agent on the heating roller 24.

In the second embodiment, the release agent A is a carnauba wax (carnauba wax No. 1 powder, a product of S. Kato & Co.); the release agent B is a paraffin wax (HNP-9, a product of Nippon Seiro Co., Ltd.); the release agent C is a polyethylene wax (Licowax PE130, a product of Clariant Japan K.K.); the release agent D is a polypropylene wax (NP056, a product of Mitsui Chemicals, Inc.); and the release agent E is dimethyl silicone oil (KF96SS-100CS, a product of Shin-Etsu Chemical Co., Ltd.).

The release agents A to E are also contained in the toner 36Bk, 36Y, 36M, and 36C (FIG. 2) through a process similar to that in the first embodiment.

In an evaluation of the second embodiment, after the release agent to be contained in the toner 36Bk, 36Y, 36M, and 36C (release agent contained in toner) and the release agent to be coated on the heating roller 24 (first rotational member) were selected, the fixing margin was measured. Further, after the surface temperature of the heating roller 24 was set at 160° C., the duplex printing was conducted continuously for 3000 sheets in only yellow at 100% duty. Then, it was evaluated whether the toner 36Bk, 36Y, 36M, and 36C stuck to a portion of the sheet 14 where no image was printed. Further, brightness was measure with GM-26D at 75° C. on a first surface of a first sheet (printed for the first time in the duplex printing) and a first surface of a 3000^{th} sheet after 3000 sheets were printed.

Results of the evaluation are shown in Table 2 to Table 4. In Table 2, a range of surface temperature at which no fixing problem occurred is shown by a lower limit of the temperature range and an upper limit of the temperature range. Further, a sheet wound temperature is shown at which the surface temperature of the heating roller 24 became too high and the sheet 14 was wound on the heating roller 24, thereby not obtaining an image. A toner peeled off temperature is shown at which the surface temperature of the heating roller 24 became too low and the toner image was peeled off from the sheet 14, thereby not obtaining an image with good quality.

TABLE 2

| | | Release | | | | |
|---|---|---|---|---|---|---|
| | | agent | | | Toner | |
| | Release | coated | Lower limit | Upper limit | image | Sheet |
| | agent | on | of | of | peeled off | wound |
| | contained | heating | temperature | temperature | temperature | temperature |
| | in toner | roller | range (° C.) | range (° C.) | (° C.) | (° C.) |
| Example 2-1 | A | A | 150 | 200 | 140 | 210 |
| Example 2-2 | B | B | 150 | 210 | 140 | 220 |
| Example 2-3 | C | C | 150 | 210 | 140 | 220 |
| Example 2-4 | D | D | 150 | 200 | 140 | 210 |
| Example 2-5 | B | D | 150 | 190 | 140 | 200 |
| Example 2-6 | D | B | 150 | 200 | 140 | 210 |
| Comparative | A | E | 150 | 190 | 140 | 200 |
| Example 21 | | | | | | |
| Comparative | B | E | 150 | 190 | 140 | 200 |
| Example 2-2 | | | | | | |
| Comparative | D | E | 150 | 190 | 140 | 200 |
| Example 2-3 | | | | | | |

TABLE 3

| | Release agent | Release agent | |
|---|---|---|---|
| | contained in | coated on | |
| | toner | heating roller | Toner attachment |
| Example 2-1 | A | A | No (good image) |
| Example 2-2 | B | B | No (good image) |
| Example 2-3 | C | C | No (good image) |
| Example 2-4 | D | D | No (good image) |
| Example 2-5 | B | D | No (good image) |
| Example 2-6 | D | B | No (good image) |
| Comparative | A | E | Yes (poor image) |
| Example 21 | | | |
| Comparative | B | E | Yes (poor image) |
| Example 2-2 | | | |
| Comparative | D | E | Yes (poor image) |
| Example 2-3 | | | |

TABLE 4

| | Release | Release | Bright- | | |
|---|---|---|---|---|---|
| | agent | agent coated | ness | Brightness | |
| | contained | on heating | First | 3000^{th} | Brightness |
| | in toner | roller | sheet | sheet | difference |
| Example 2-1 | A | A | 50 | 50 | 0 |
| Example 2-2 | B | B | 60 | 60 | 0 |
| Example 2-3 | C | C | 60 | 60 | 0 |
| Example 2-4 | D | D | 50 | 50 | 0 |
| Example 2-5 | B | D | 50 | 60 | 10 |
| Example 2-6 | D | B | 60 | 50 | 10 |
| Comparative | A | E | 30 | 50 | 20 |
| Example 21 | | | | | |
| Comparative | B | E | 30 | 60 | 30 |
| Example 2-2 | | | | | |
| Comparative | D | E | 30 | 50 | 20 |
| Example 2-3 | | | | | |

### EXAMPLE 2-1

Similar to Example 1-1, the release agent A was contained in the toner 36Bk, 36Y, 36M, and 36C. 1×10⁻³ g/cm² of the release agent A was coated on the heating roller 24 of the fixing unit 23. In the range of 150° C. to 200° C., the fixing operation was properly performed. Accordingly, the fixing margin was found to be 50° C., thereby obtaining the good result. When the printing was performed continuously, the toner 36Bk, 36Y, 36M, and 36C did not stick to the sheet 14, and an image with good quality was obtained. The first sheet had brightness of 50, and the 3000^{th} sheet had brightness of 50.

Accordingly, the difference in brightness between the start and the end of the printing is zero, thereby obtaining an image with good quality throughout the continuous printing.

### EXAMPLE 2-2

The release agent B was contained in the toner 36Bk, 36Y, 36M, and 36C, and 1×10⁻³ g/cm² of the release agent B was coated on the heating roller 24 of the fixing unit 23. In the range of 150° C. to 210° C., the fixing operation was properly performed. Accordingly, the fixing margin was found to be 60° C., thereby obtaining the good result. When the printing was performed continuously, the toner 36Bk, 36Y, 36M, and 36C did not stick to the sheet 14, and an image with good quality was obtained. The first sheet had brightness of 60, and the 3000^{th} sheet had brightness of 60. Accordingly, the difference in brightness between the start and the end of the printing is zero, thereby obtaining an image with good quality throughout the continuous printing.

### EXAMPLE 2-3

The release agent C was contained in the toner 36Bk, 36Y, 36M, and 36C, and 1×10⁻³ g/cm² of the release agent C was coated on the heating roller 24 of the fixing unit 23. In the range of 150° C. to 210° C., the fixing operation was properly performed. Accordingly, the fixing margin was found to be 60° C., thereby obtaining the good result. When the printing was performed continuously, the toner 36Bk, 36Y, 36M, and 36C did not stick to the sheet 14, and an image with good quality was obtained. The first sheet had brightness of 60, and the 3000^{th} sheet had brightness of 60. Accordingly, the difference in brightness between the start and the end of the printing is zero, thereby obtaining an image with good quality throughout the continuous printing.

### EXAMPLE 2-4

The release agent D was contained in the toner 36Bk, 36Y, 36M, and 36C, and 1×10⁻³ g/cm² of the release agent D was coated on the heating roller 24 of the fixing unit 23. In the range of 150° C. to 200° C., the fixing operation was properly performed. Accordingly, the fixing margin was found to be 50° C., thereby obtaining the good result. When the printing was performed continuously, the toner 36Bk, 36Y, 36M, and 36C did not stick to the sheet 14, and an image with good quality was obtained. The first sheet had brightness of 50, and the 3000^{th} sheet had brightness of 50. Accordingly, the difference in brightness between the start and the end of the printing is zero, thereby obtaining an image with good quality throughout the continuous printing.

### EXAMPLE 2-5

The release agent B was contained in the toner 36Bk, 36Y, 36M, and 36C, and 1×10⁻³ g/cm² of the release agent D was coated on the heating roller 24 of the fixing unit 23. In the range of 150° C. to 190° C., the fixing operation was properly performed. Accordingly, the fixing margin was found to be 40° C., thereby obtaining the good result. When the printing was performed continuously, the toner 36Bk, 36Y, 36M, and 36C did not stick to the sheet 14, and an image with good quality was obtained. The first sheet had brightness of 50, and the 3000^{th} sheet had brightness of 60. Accordingly, the difference in brightness between the start and the end of the printing is 10, which was not distinguishable with naked eyes. Accordingly, it was possible to obtain an image with good quality throughout the continuous printing.

### EXAMPLE 2-6

The release agent D was contained in the toner 36Bk, 36Y, 36M, and 36C, and 1×10⁻³ g/cm² of the release agent B was coated on the heating roller 24 of the fixing unit 23. In the range of 150° C. to 200° C., the fixing operation was properly performed. Accordingly, the fixing margin was found to be 50° C., thereby obtaining the good result. When the printing was performed continuously, the toner 36Bk, 36Y, 36M, and 36C did not stick to the sheet 14, and an image with good quality was obtained. The first sheet had brightness of 60, and the 3000^{th} sheet had brightness of 50. Accordingly, the difference in brightness between the start and the end of the printing is 10, which was not distinguishable with naked eyes. Accordingly, it was possible to obtain an image with good quality throughout the continuous printing.

### COMPARATIVE EXAMPLE 2-1

The release agent A was contained in the toner 36Bk, 36Y, 36M, and 36C, and 1×10⁻³ g/cm² of the release agent E was coated on the heating roller 24 of the fixing unit 23. In the range of 150° C. to 190° C., the fixing operation was properly performed. Accordingly, the fixing margin was found to be 40° C., thereby obtaining the good result. When the printing was performed continuously, the toner 36Bk did stick to the sheet 14 in an area with no image, and an image with poor quality was obtained. The first sheet had brightness of 30, and the 3000^{th} sheet had brightness of 50. Accordingly, the difference in brightness between the start and the end of the printing is large. Accordingly, it was difficult to obtain an image with good quality throughout the continuous printing.

Further, after the continuous printing, the toner 36Bk, 36Y, 36M, and 36C did stick to the sheet 14 in an area with no image, and an image with poor quality was obtained. At this time, in the developing unit 13Bk, the toner 36Bk stuck to the photosensitive drum 31Bk at several locations. In the duplex printing, when the first surface of the sheet 14 was printed and the release agent E stuck to the first surface, the release agent E also stuck to the transfer belt 16 after the first surface was printed. In the developing process, the release agent E was in a liquid state and a sticky state. Accordingly, the toner 36Bk stuck to the surface of the photosensitive drum 31Bk in an area with no latent image, thereby obtaining an image with poor quality.

On the other hand, in Examples 2-1 to 2-6, the release agents A to D coated on the heating roller 24 were in a solid state at a room temperature with no sticky property. Accordingly, the toner 36Bk did not stick to the surface of the photosensitive drum 31Bk in an area with no latent image, thereby obtaining an image with good quality.

### COMPARATIVE EXAMPLE 2—2

The release agent B was contained in the toner 36Bk, 36Y, 36M, and 36C, and 1×10⁻³ g/cm² of the release agent E was coated on the heating roller 24 of the fixing unit 23. In the range of 150° C. to 190° C., the fixing operation was properly performed. Accordingly, the fixing margin was found to be 40° C., thereby obtaining the good result. When the printing was performed continuously, the toner 36Bk did stick to the sheet 14 in an area with no image, and an image with poor quality was obtained. The first sheet had brightness of 30, and the 3000^{th} sheet had brightness of 60. Accordingly, the difference in brightness between the start and the end of the printing is large. Accordingly, it was difficult to obtain an image with good quality throughout the continuous printing.

### COMPARATIVE EXAMPLE 2-3

The release agent D was contained in the toner 36Bk, 36Y, 36M, and 36C, and 1×10⁻³ g/cm² of the release agent E was coated on the heating roller 24 of the fixing unit 23. In the range of 150° C. to 190° C., the fixing operation was properly performed. Accordingly, the fixing margin was found to be 40° C., thereby obtaining the good result. When the printing was performed continuously, the toner 36Bk did stick to the sheet 14 in an area with no image, and an image with poor quality was obtained. The first sheet had brightness of 30, and the 3000^{th} sheet had brightness of 50. Accordingly, the difference in brightness between the start and the end of the printing is large. Accordingly, it was difficult to obtain an image with good quality throughout the continuous printing.

As apparent from the results described above, when at least one of the carnauba wax, the polypropylene wax, the polyethylene wax, and the paraffin wax is coated on the heating roller 24, it is possible to obtain the good fixing margin. In the duplex printing, it is possible to obtain an image with good quality. More preferably, the release agent same as that contained in the toner 36Bk, 36Y, 36M, and 36C is coated on the heating roller 24. Accordingly, it is possible to obtain an image with good quality without a large change in brightness in the continuous printing, thereby improving image quality.

In the embodiments, the colorant includes carbon black, phthalocyanine blue, permanent brown FG, brilliant first scarlet, pigment green B, rhodamine-B base, sorbetto red 49, sorbetto red 146, pigment blue 15:3, sorbetto blue 35, quinacridone, carmine 6B, and disazo yellow.

In the embodiments, the release agent to be coated on the heating roller 24 includes an ester-based wax, an olefin-based wax, and a hydrocarbon-based wax.

In the embodiments, the toner 37Bk is manufactured with a well-known method such as a mixing-crashing method, a spry-dry method, and a polymerization method. It is preferred that the toner 37Bk has a weight average particle diameter of 4 to 15 μm. Further, It is preferred to mix the toner 36Bk with an additive such as a charge control agent, a conductivity control agent, a body pigment, a reinforcement filler such as a fibril substance, an anti-oxidant, an anti-aging agent, a flow promoter, and a cleaning helper. Further, it is preferred to add inorganic powder for improving environmental durability, charge stability, development performance, flow property, and storage life. The inorganic powder includes hydrophobized inorganic fine powder, and is added to the toner 36Bk for process treatment. The hydrophobized inorganic fine powder includes silica fine powder, titanium oxide power, a hydrophobized substance thereof, and a mixture thereof.

The disclosure of Japanese Patent Application No. 2005-242168, filed on Aug. 24, 2005, is incorporated in the application.

While the invention has been explained with reference to the specific embodiments of the invention, the explanation is illustrative and the invention is limited only by the appended claims.

What is claimed is:

1. An image forming apparatus, comprising:
a developing device for forming a developer image containing at least a colorant, a first releasing agent, and a binder resin;
a transfer member for transferring the developer image to a recoding medium; and
a fixing unit having a first rotational member for heating the developer image transferred to the recoding medium and a second rotational member for pressing the developer image against the recording medium, said first rotational member being coated with a second release agent on a surface thereof.

2. The image forming apparatus according to claim 1, wherein said first rotational member is coated with the second release agent in a range of 1×10⁻⁶ g/cm² to 1×10⁻² g/cm².

3. The image forming apparatus according to claim 1, wherein said first rotational member is coated with the second release agent including at least one of carnauba wax, polypropylene wax, polyethylene wax, and paraffin wax.

4. The image forming apparatus according to claim 1, wherein said first rotational member is coated with the second release agent including at least one of an ester-based wax, an olefin-based wax, and a hydrocarbon-based wax.

5. The image forming apparatus according to claim 1, wherein said first rotational member is coated with the second release agent same as the first release agent.

6. The image forming apparatus according to claim 1, wherein said first rotational member is coated with the second release agent in a solid state at a room temperature and capable of melting upon applying heat.

7. The image forming apparatus according to claim 1, wherein said developing device forms the developer image capable of melting upon applying heat.

8. The image forming apparatus according to claim 1, wherein said first rotational member includes a surface portion formed of a thermoplastic fluoro resin such as PFA (tetrafluoroethylene-perfluoroalkylvinylether copolymer), said surface portion being coated with the second release agent.

9. The image forming apparatus according to claim 1, wherein said first rotational member includes a surface portion formed of at least one of a fluoro rubber, tetrafluoro-ethylene, and nylon.

10. The image forming apparatus according to claim 1, wherein said first rotational member has a cylindrical shape with an outer circumferential surface, said outer circumferential surface coated with the second release agent on an entire area thereof.

11. The image forming apparatus according to claim 1, wherein said first rotational member includes a surface portion contacting with the developer image.

12. The image forming apparatus according to claim 1, wherein said developing device includes a plurality of developing units for forming developer images in different colors, said developer images containing the first releasing agent.

13. The image forming apparatus according to claim 1, further comprising a reverse transport path for returning the recording medium to the developing device after the recording medium passes through the fixing unit; a discharge path for transporting the recording medium to a stacker after the recording medium passes through the fixing unit; and a selection unit for selecting one of the reverse transport path and the discharge path.
